(19) United States
(12) Patent Application Publication
(10) Pub. No.: US 2007/0140488 A1
(43) Pub. Date: Jun. 21, 2007

(54) Restriction of broadcast session key use by secure module decryption policy

(75) Inventors: Srinivas Murthy Dharmaji, Burlingame, CA (US); Hong Jiang, Westfield, NJ (US); Peter Andrew Mataga, Sparta, NJ (US); Cary Torkelson, Allendale, NJ (US); Edgar Villanueva, Rockaway, NJ (US)

Correspondence Address: BINGHAM MCCUTCHEN LLP, 2020 K Street, N.W., Intellectual Property Department, WASHINGTON, DC, 20006, US

(73) Assignee: Roundbox, Inc.

(21) Appl. No.: 11/641,042

(22) Filed: Dec. 19, 2006

Related U.S. Application Data
(60) Provisional application No. 60/752,060, filed on Dec. 21, 2005.

(51) Int. Cl. H04N 7/167

(52) U.S. Cl. 380/212; 380/223; 380/231

(57) ABSTRACT

A method is provided for restricting or enhancing broadcast content access on a per-subscriber basis across a population of subscribers, all of whom have a valid content access key to such content, without necessitating changes to the current standard schemes and protocols for distributing content access keys and broadcasting the traffic keys associated with the broadcast data itself, and without trusting the application that processes the data. A method of handling a multimedia broadcast in a device comprises receiving broadcast content in a media stream encrypted using a traffic key, receiving the traffic key encrypted using a session key, and receiving broadcast attributes encrypted using the traffic key and the session key, wherein use of the media stream by the device is controlled using the broadcast attributes and using an access policy in the device.

### CROSS-REFERENCE TO RELATED APPLICATIONS

This application claims the benefit of provisional application Ser. No. 60/752,060, filed Dec. 21, 2005.

### BACKGROUND OF THE INVENTION

1. Field of the Invention

The present invention relates to the secured broadcast of multimedia and data, and more specifically to methods used to restrict access to said broadcasts on a subscriber-by-subscriber basis even when all subscribers have valid content access keys.

2. Description of the Related Art

Restricting access to broadcast content is of paramount importance to content providers. However, current schemes using broadcast session keys fail to provide flexibility to provide customized access to different content subscribers; they provide the same level access to all authorized subscribers for a specific service, disallowing the ability of content providers to limit or enhance that service to specific subscribers. It is important to understand that, in an environment where transmittal of a broadcast session key to the entire subscriber population is an expensive and resource intensive operation, the ability to alter the behavior of a specific subscriber's content session key in between such global transmittals can be of significant value to the content provider. Real life examples of these types of subscriber specific limitations include limiting access to the broadcast content during specific times of day or based on a subscriber's location, limited access to content based on the content's rating, or simply expiring a subscriber's access to the content before the next general transmittal of the session key.

Broadcast session keys are typically used to provide large granularity service protection. The distribution of broadcast session keys normally require each user to undergo point-to-point authentication with a subscription manager to authorize the user and obtain the key. Due to the traffic demands of distributing broadcast session keys to the entire subscription base, session keys are distributed relatively infrequently.

Session keys are often bundled with a rights object that describes how the associated content can be used. The rights object typically describe the entire content object, be it a broadcast multimedia stream, a broadcast file, a data file, or some other content type. In the case of a multimedia stream, the rights object is applicable for the entire duration of the session key.

Rights objects are useful when all broadcast clients that receive a stream are trusted to execute the rights object. However, this may not be the case: a client may be executing a non-trusted application. To address this, a common architecture is to equip broadcast clients with a secure module (SM) that shares a client-specific secret (CSS) with the broadcast network infrastructure. The session key is then encrypted using the shared secret in some systematic fashion, in such a way that the application cannot itself decrypt the key.

The media stream is encrypted with a rapidly varying traffic key which may be valid for only a matter of seconds. The traffic key is encrypted with the session key, and typically broadcast separately from the media stream. Media stream packets are tagged indicating which traffic key was used to encrypt the packet. The broadcast client will ask the SM to decrypt the traffic key based on the encrypted session key the application has access to. Since only the SM knows the CSS, it and it alone can decrypt the traffic key. The decrypted traffic key can then be used to decrypt some set of media stream packets, typically on the order of a hundred or more before a new traffic key is required.

The purpose of this mechanism is to ensure that even if a traffic key is shared by a rogue application to others, the key is valid for such a short period of time that it unlikely that it can be shared with another broadcast client such as a set top box or mobile device in a timely enough fashion to be of use to the unauthorized client.

However, this conventional mechanism does not provide the capability to restrict the use of session keys on a per-subscriber basis. A need arises for a technique that provides the capability to protect the broadcast content using traffic keys that offer finer-grained control to that content in a tamper-proof manner.

### SUMMARY OF THE INVENTION

The present invention provides a technique for restricting or enhancing broadcast content access on a per-subscriber basis across a population of subscribers, all of whom have a valid content access key to such content, without necessitating changes to the current standard schemes and protocols for distributing content access keys and broadcasting the traffic keys associated with the broadcast data itself, and without trusting the application that processes the data. This is accomplished via two mechanisms. First, a tamper proof, subscriber-specific access policy is transmitted at the time a subscriber obtains a broadcast access key. This policy may describe restrictions on use based on time, location, content rating, or other specifications that are pertinent to the broadcast channel. Second, as the broadcast itself is transmitted, attributes about that broadcast are sent in a tamper proof way along with, or embedded in, the traffic keys, and are used to determine if the conditions set forth in the access policy are satisfied. Broadcast attributes correspond to a specific traffic key such that an application on the receiving device can not alter the broadcast attributes, or use non-corresponding broadcast attributes to successfully decrypt the traffic key. Additional device and user-specific profile data can be combined with the broadcast attributes to evaluate the access policy. Only if the access policy is satisfied can the broadcast content can be viewed by, or otherwise made available to the user.

A method of viewing a multimedia broadcast in a device comprises receiving broadcast content in a media stream encrypted using a traffic key, receiving the traffic key encrypted using a session key, and receiving broadcast attributes encrypted using the traffic key and the session key, wherein use of the media stream by the device is controlled using the broadcast attributes and using an access policy in the device.

The access policy may define restrictions on use of the media stream. The defined restrictions on viewing of the media stream may be on a subscriber-by-subscriber basis. The method may further comprise using the broadcast attributes to evaluate whether the access policy is satisfied for a current broadcast content and preventing decryption of the traffic key if the access policy is not satisfied for the current broadcast. Using the broadcast attributes to evaluate whether the access policy is satisfied for a current broadcast content may be based on an age of a user of the device and on a rating of the broadcast content. Using the broadcast attributes to evaluate whether the access policy is satisfied for a current broadcast content may be based on geographic area. The geographic area may include at least one of a city, a road, an airport, a public transportation terminal, a sports arena, an amusement park, a museum, and a public or private place of business. Using the broadcast attributes to evaluate whether the access policy is satisfied for a current broadcast content may be based on a time of day. Using the broadcast attributes to evaluate whether the access policy is satisfied for a current broadcast content may be based on additional data included in the media stream. Using the broadcast attributes to evaluate whether the access policy is satisfied for a current broadcast content may be based on additional data included in the broadcast content that is only made available to selected members. The additional data may include at least one of: fantasy sporting even information, sporting event information, information related to characters or actors playing those characters, information related to locations or props, information related to writers, directors, producers, or others involved in production of the broadcast content, commentary concerning the broadcast content, and additional languages for the broadcast content. Using the broadcast attributes to evaluate whether the access policy is satisfied for a current broadcast content is based on expiration information of a user subscription. Using the broadcast attributes to evaluate whether the access policy is satisfied for a current broadcast content is based on allowing a user to view a particular broadcast stream for only a specified amount of time, which may be based on a count of a number of traffic keys decrypted.

The method may further comprise using at least one of the broadcast attributes, local device information, user profile information, and history information to evaluate whether the access policy is satisfied for a current broadcast and preventing decryption of the traffic key if the access policy is not satisfied for the current broadcast. The broadcast may comprise data used by an application on the device. The device may be a mobile device capable of displaying or otherwise using the media stream. The session key and the access policy may be used to enable or restrict access to one or more related media streams or broadcast channels, wherein rights for each related media stream or broadcast channel are different. The access policy may be received and securely stored in the device, such that the access policy can not be manipulated by applications on the device and cannot subsequently be used to decrypt a media stream. The access policy may be made available to applications on the device for purposes including at least one of displaying the access policy to a user of the device, or altering a user interface by which the user gains access to the media stream or broadcast channel or views the media stream or broadcast channel. The access policy may include at least one of a set of parameter values, a set of ranges of parameter values, a set of regular expressions, a matching predicate, or a matching algorithm.

The method may further comprise encrypting the traffic key using the broadcast attributes, wherein the broadcast attributes may be bound to the traffic key such that neither the traffic key nor the broadcast attributes can be modified by any application on the device and result in successful decryption of the media stream. The broadcast attributes, which are encrypted using the traffic key, may be bound the traffic key to the broadcast attributes such that neither the traffic key nor the broadcast attributes can be modified by any application on the device and result in successful decryption of the media stream. The broadcast attributes encrypted using the traffic key may be available to an application on the device for purposes including modifying the user-interface based on the broadcast attributes or otherwise informing the user of the broadcast attributes. An application on the device may be unable to use non-corresponding broadcast attributes and traffic keys to successfully satisfy the access policy and decrypt the media stream. The broadcast attributes may be embedded in the encrypted traffic key, and the broadcast attributes are not received separately from the encrypted traffic key. The received broadcast attributes may include metadata relating to the media stream, including at least one of a content type of the media stream, and a content rating of the media stream. The received broadcast attributes may include network environment data, including at least one of as a broadcast tower location, a time of day, network traffic information, and network status data.

The method may further comprise using additional profile information not included with the media stream to determine whether the device can decrypt the received traffic keys, wherein the additional profile information includes at least one of: local network environment data, including at least one of: a GPS location of the device, a quality of service, a time zone, a signal strength, and other local network environment data of the device, device-specific data, including at least one of: an ability of the device to record a media stream, an ability of the device to retransmit a media stream, and other device-specific capabilities, user-specific profile data, including at least one of: a gender of a user of the device, an age of the user of the device, and interest of the user of the device, and other data relating to a user of the device, and usage history of the device, including at least one of: usage of a media stream or broadcast channel, usage of applications on the device, and other data relating to how the device has been previously used.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary flow diagram illustrating a process by which a content receiver securely obtains a valid session key a corresponding, tamper proof access policy from a subscription service.

FIG. 2 is an exemplary flow diagram illustrating a process by which broadcast content is encrypted with changing traffic keys so that rogue applications can not effectively share traffic keys with other applications such that those other applications gain access to the content.

FIG. 3 is an exemplary flow diagram illustrating a process similar to that shown in FIG. 2, with the exception being that the traffic keys are broadcast in the same stream as the media.

FIG. 4 is an exemplary flow diagram illustrating a process in which the broadcast attributes are tamper-proofed by encrypting them with the session key and traffic key. The encrypted broadcast attributes are then sent along with the corresponding traffic keys.

FIG. 5 is an exemplary flow diagram illustrating a process by which broadcast attributes are embedded within the traffic key itself.

FIG. 6 is an exemplary flow diagram illustrating a process by which the broadcast attributes are tamper-proofed by signing them with the traffic key. The signed broadcast attributes are then sent along with the corresponding traffic keys. The broadcast attributes themselves are sent in the clear.

FIG. 7 is an exemplary flow diagram illustrating a process by which an application calls the secure module to decrypt traffic keys by providing the associated broadcast attributes. The secure module verifies that the broadcast attributes have not been altered and match this specific traffic key. Local profile data can be used in conjunction with the verified broadcast attributes to determine if the access policy is satisfied, and if so, decrypts the traffic key and stores it where the application can access it.

FIG. 8 is an diagram illustrating an application of the present invention to restrict access of the broadcast to select users based on individual restriction policies, broadcast policy data, and local device and user profile information.

FIG. 9 is a block diagram of an exemplary broadcast receiver in which the present invention may be implemented.

### DETAILED DESCRIPTION OF THE INVENTION

The present invention provides a technique for restricting or enhancing broadcast content access on a per-subscriber basis across a population of subscribers, all of whom have a valid content access key to such content, without necessitating changes to the current standard schemes and protocols for distributing content access keys and broadcasting the traffic keys associated with the broadcast data itself, and without trusting the application that processes the data. This is accomplished via two mechanisms. First, a tamper proof, subscriber-specific access policy is transmitted at the time a subscriber obtains a broadcast access key. This policy may describe restrictions on use based on time, location, content rating, or other specifications that are pertinent to the broadcast channel. Second, as the broadcast itself is transmitted, attributes about that broadcast are sent in a tamper proof way along with, or embedded in, the traffic keys, and are used to determine if the conditions set forth in the access policy are satisfied. Broadcast attributes correspond to a specific traffic key such that an application on the receiving device can not alter the broadcast attributes, or use non-corresponding broadcast attributes to successfully decrypt the traffic key. Additional device and user-specific profile data can be combined with the broadcast attributes to evaluate the access policy. Only if the access policy is satisfied can the broadcast content can be viewed by, or otherwise made available to the user.

A number of terms useful to understanding the present invention are described as follows:

Access Policy (AP): The access policy is used to evaluate whether or not a particular traffic key should be decrypted at the current time, given the inputs received from the broadcast attributes (BA) and local profile data (LPD). An access policy may contain, for example, a set of parameter values or ranges, a set of regular expressions, a matching predicate, or a matching algorithm explicitly specified in some language.

Broadcast Attributes (BA): Broadcast attributes includes metadata concerning the broadcast itself, such as content type, content rating or other data pertaining to the particular content being broadcast. Broadcast attributes can also include general network environment data such as broadcast tower location, time of day, traffic information, or other data related to the status of the network at the time of broadcast and applicable to one or more subscribers in that network environment.

Broadcast Stream (BS): Used interchangeably with media stream.

Client Specific Secret (CSS): The client specific secret is an identifier that can be used to uniquely identify every device in a network. It is stored in the SM, and is known only to the SM and the service provider. The CSS is used to encrypt the SK at the service provider, and to decrypt the SK in the SM on the user's device.

Local Profile Data (LPD): Local profile data includes local network environment data, such as exact GPS location of the receiver, quality of service, time zone, signal strength, or other data related specifically to the local network environment of the device receiving the broadcast. LPD can also include device-specific data, such as the device's ability to record a broadcast, its ability to retransmit a broadcast, or other device-specific capabilities that may be of interest to the broadcaster of the content. LPD can also include user-specific profile data, such as the user's gender, age, interests, or other data that defines the user. Lastly, LPD can also include usage history of the device, including usage of the broadcast channel, usage of certain applications on the device, or other characteristics the describe how the device has been previously used.

Media Stream (MS): The media stream is the actual content which the user is receiving. This is typically multimedia content such as audio and video, but is can also refer to any data stream that application on the user's device can use, such as stock quotes, sports play-by-play, traffic, weather, and news.

Secure Module (SM): The secure module is a piece of hardware and/or software on a device that securely stores data and executes certain computations. In the context of this invention, it is a trusted mechanism used to allow or deny a user access to a particular media stream by controlling decryption of traffic keys. The secure module contains a client specific secret (CSS) that is known only to the SM and the service provider. No application on the device has direct access to the CSS.

Session Key (SK): The session key is used to allow users access to broadcasts on a particular broadcast channel for a specified amount of time. Devices may initiate contact with the service provider to obtain a session key, or the set of all separately encrypted keys may be broadcast. In either case, this is a heavyweight operation that is only performed as session keys expire.

Traffic Key (TK): Traffic keys are short-lived keys used to decrypt the broadcast stream. Traffic keys are broadcast with, or in parallel with the media stream (see illustrations 2 and 3), and are encrypted using the session key (SK). Thus, a valid SK is needed to successfully decrypt a traffic key. The decrypted traffic key can then be used to decrypt the broadcast stream.

The present invention provides the capability for per-subscriber, per-session filtering of a content stream, even when all subscribers have the same valid session key (SK), by distributing an access policy (AP), which can vary by subscriber, to each subscriber when they obtain the session key. The AP will then be used dynamically by the SM to determine if a particular traffic key can be decrypted or not, allowing the policy to apply at much finer time granularity than the session key lifetime.

The AP must be distributed securely in such a way that the SM will not use the SK without the corresponding AP. Applications are not permitted to alter the rules specified by the AP and subsequently use the altered AP to decrypt a traffic key (TK).

There are a number of mechanisms that may be used to make the policy tamperproof. For example, the client might receive at session key distribution time:
SK′=Encrypted SK=E(SK,CSS)
AP′=Encrypted AP=E(AP,SK)
where E(object,key) means the object is encrypted with the key. SK′ and AP′ are passed to the SM, which can recover the AP once SK′ is decrypted. Since the application does not have SK, it cannot forge AP′.

Any other mechanism that allows the SM to verify AP based on possession of SK can be used to make the policy tamper-proof, even if it is exposed to the application. For example, the client receives the AP in the clear and a signature:
SK′=E(SK,CSS)
AP(in the clear)
APsig=H(AP+SK)
where H(object) means a cryptographically secure hash and+indicates concatenation. SK′, AP and APsig are passed to the SM, which can verify that AP is associated with SK. Since the application does not have SK, it cannot forge APsig.

In this manner, or after decryption by the SM, AP can optionally be exposed to the application so that it can use the information to display the rules to the subscriber, or to alter the user-interface of the application accessing the broadcast stream.

Note that in all of the above the SK itself need not be altered to support this scheme; it can be generated using the standards already adopted for the broadcast technology being used.

Once acquired securely, the AP provides sufficient information for a filter policy to be applied. For example:
a set of parameter values or ranges
a set of regular expressions
a matching predicate
a matching algorithm explicitly specified in some language

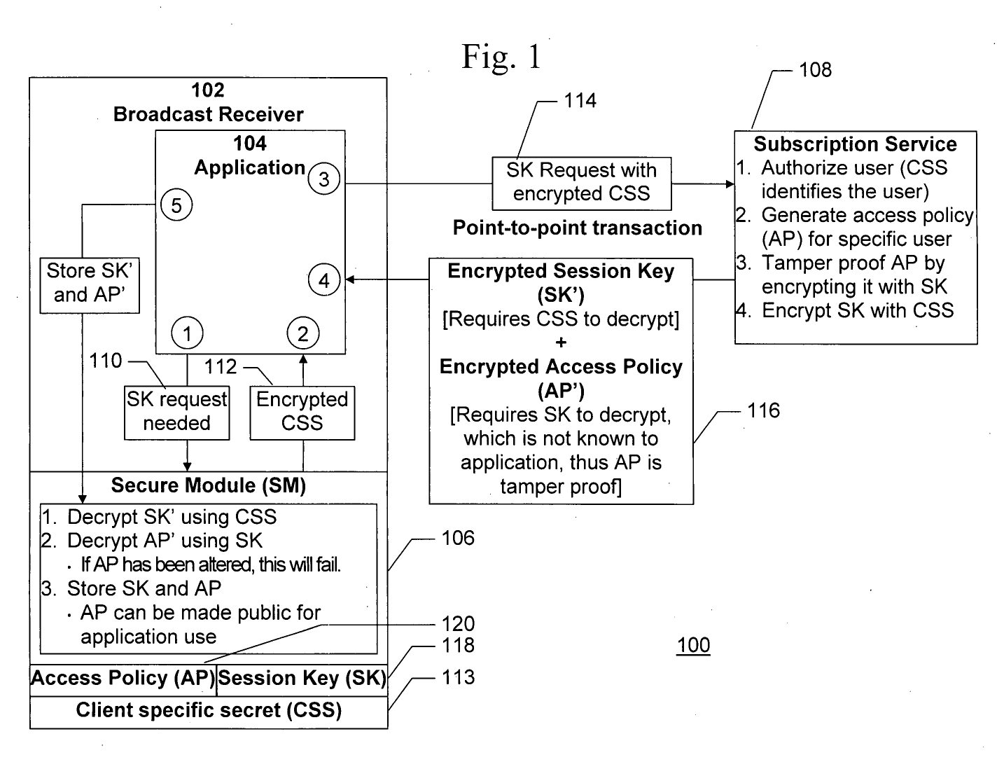

FIG. 1 illustrates the end-to-end process 100 by which a device obtains a broadcast session key and associated access policy. The access policy is tied to the encrypted session key so as to tamper-proof the policy. Any alteration of the policy by the application will result in a failure to successfully decrypt and store the session key.

In process 100, a broadcast receiver 102 includes an application 104, which communicates with Secure Module (SM) 106 and Subscription Service 108 of the service provider network to obtain the keys needed to decrypt broadcast content. When application 104 detects that a new session key is (or will soon be) required, it makes a request to the service provider network, identifying the user or device. The identity of the user will be authenticated in standard ways, which may involve the SM or may not. For example, in step 1, application 104 sends a request 110 for a Session Key (SK) to SM 108. In step 2, SM 106 generates an encrypted Client-Specific Secret (CSS) 112 from stored CSS 113, and transmits it to application 104. In step 3, application 103 transmits a request 114 for an SK along with the encrypted CSS to the Subscription Service 108 of the service provider network. Subscription Service 108 authorizes the user, using the CSS to identify the user, generate an access policy (AP) specific to the user, tamper-proofs the AP by encrypting it with SK, and encrypts SK with the CSS. In step 4, application 104 receives the Encrypted Session Key (SK′) and the Encrypted Access Policy (AP′) 116 transmitted from Subscription Service 108. In step 5, application 104 stores SK′ and AP′ in SM 106. SM 106 decrypts SK′ using the CSS 113 (forming SK 118), decrypts AP′ using SK 118 (forming AP 120), and stores SK 118 and AP 120. If AP has been altered, this decryption of AP′ using SK 118 will fail.

Even though every subscriber will receive the same session key, this access policy allows the service provider to better control the circumstances under which this particular user can view, or otherwise use, the broadcast. For example the access policy for one subscriber can be as follows:

Only allow viewing of broadcast if:

GPS location of the device is within a baseball park
Content rating of broadcast is appropriate for those aged under 21
The user has been viewing the broadcast program for less than 30 minutes

Another subscriber with the same valid session key might have the following access policy:

Only allow viewing of broadcast if:

GPS location of the device is within a baseball park

In this example, the second subscriber has access to content ratings and has no restriction on viewing time.

Once the access policy for this particular subscriber has been generated, the service provider ensures that an application on the subscriber's device is unable to modify the policy by encrypting the access policy with the session key. Applications do not have access to unencrypted session keys, and thus will not be able to decrypt and modify access policies. Nor will an SM that does not belong to the correct device.

Alternatively, the encrypted session key and policy may be broadcast periodically for every user.

The encrypted session key (SK′) and tamper-proof access policy (AP′ or AP plus verification information such as APsig) are transmitted to application on the subscriber's device that requested the session key. The application has no means to decrypt either value and passes it on to the secure module. The secure module uses CSS to decrypt SK′. Once decrypted, SK can be used to decrypt and/or verify AP′. Both SK and AP can be stored for future use by the secure module. Once a session key is in use, the corresponding AP may be made public to applications running on the device so that they can optionally use it to display the policy to the user, or alter the UI presented to the user. For example, an application may display a “Content not appropriate for the current viewer” if the access policy mandates that only PG material can be viewed, but the current material being received is tagged as PG-13.

The inputs to the AP algorithm must depend only on information that is securely known to the SM at the time the TK decryption is requested. For, example:
if the SM has trusted and secure access to the time of day, the AP could specify that decryption is only valid during specific time interval(s)
if the SM has trusted and secure access to the GPS location of the broadcast receiver, the AP could specify that decryption is only valid to a specific set of geographic locations
if the SM has trusted and secure access to the broadcast receiver's usage history or user profile, the AP could specify that decryption is only valid when the content is appropriate for the user of this particular receiver

In some cases, the SM is purely an embedded storage and computation device that has no secure access to profile data concerning the particular receiver in which it is embedded. Information such as time of day or receiver location can not be obtained by the SM and applied to the AP. In other cases, the information needed by the SM to check against the access policy is dependent on the broadcast itself. Information such as content type and content rating can not be known ahead of time, and can change depending on what is currently being broadcast. Under these circumstances, the information to be applied to the AP during TK decryption can be obtained from broadcast attributes included with the broadcast of the TK itself.

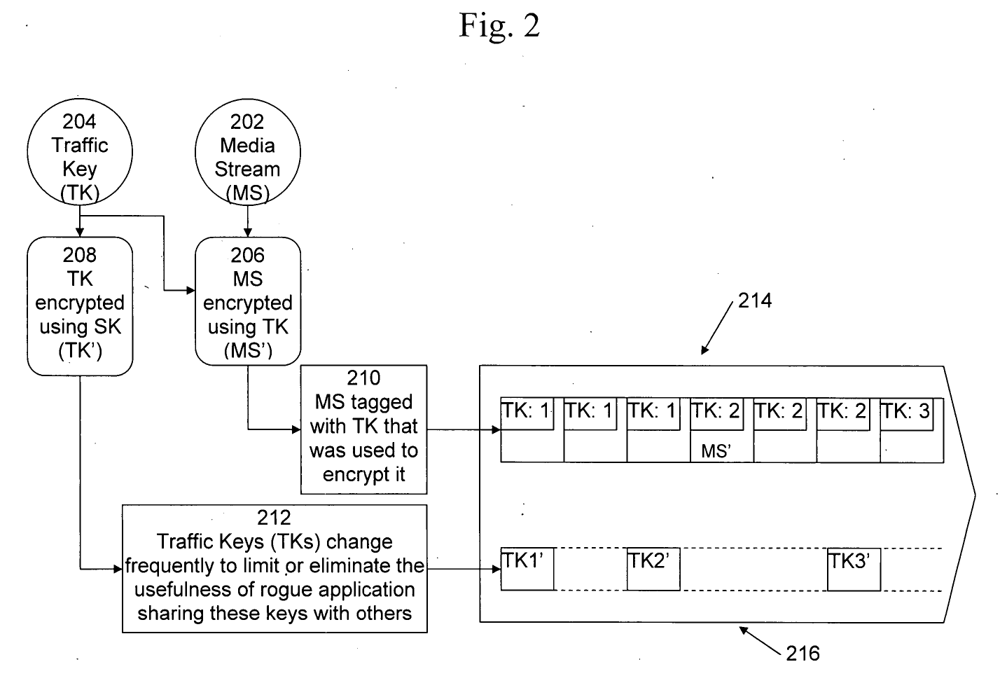

An example of a Media Stream (MS) Encrypted With a Traffic Key (TK) broadcast on a separate channel is, shown in FIG. 2. In the example shown in FIG. 2, a Media Stream (MS) 202 is sent using a TK 204. MS 202 is encrypted using TK 204 to form MS′ 206, while TK 204 is encrypted using the SK to form TK′ 208. MS′ is tagged 210 with an indication of the TK that was used to encrypt it. The TKs are frequently changed 212 to limit or eliminate the usefulness of rogue applications sharing the TK with others. Thus, a plurality of blocks of MS′ 214 are transmitted, each block tagged with an indication of the TK that was used to encrypt it. In addition, a plurality of TK's 216 are transmitted periodically on a separate channel, to be used to decrypt the corresponding blocks of MS′.

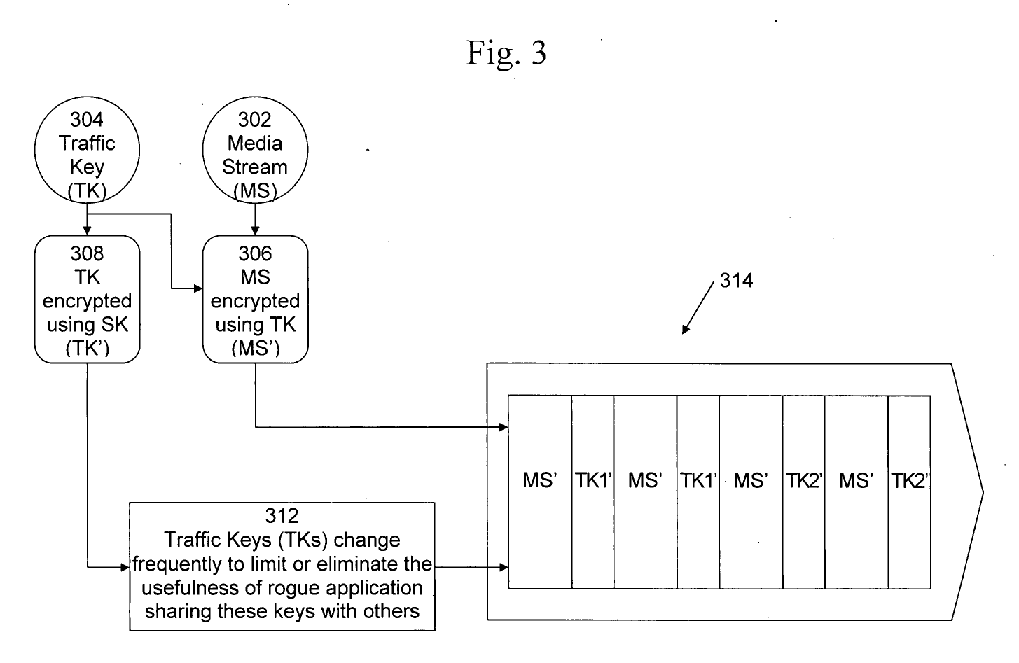

An example of a Media Stream (MS) Encrypted With a Traffic Key (TK) broadcast on a same channel is shown in FIG. 3. In the example shown in FIG. 3, a Media Stream (MS) 302 is sent using a TK 304. MS 302 is encrypted using TK 304 to form MS′ 306, while TK 304 is encrypted using the SK to form TK′ 308. The TKs are frequently changed 312 to limit or eliminate the usefulness of rogue applications sharing the TK with others. Thus, transmission stream 314 is formed that includes a plurality of blocks of MS′, along with, for each block of MS′ 214, the TK′ including the TK that was used to encrypt the block.

The broadcast attributes (BA) included with the TK needs to be provided to the receiver in a form that can not be altered by an application on the receiver and subsequently used to decrypt the broadcast stream. Binding the broadcast attributes and traffic key together can be used as a secure source of dynamic data generated by the broadcast network operator.

As for SK and AP, the relationship between the TK and BA can be made tamper-proof in several ways. One method involves encrypting the TK using the SK and the associated BA with TK and SK:
TK′=E(TK,SK)
BA′=E(E(BA,TK), SK)

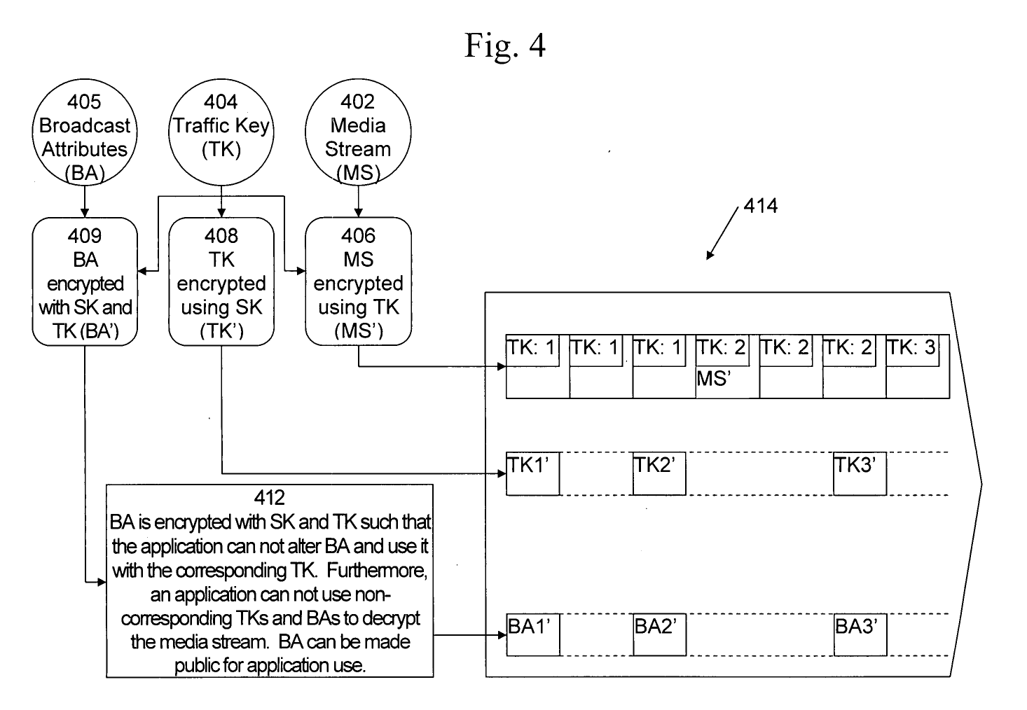

An example of this, in which tamper-proof Broadcast Attributes (BA) are tied to a specific traffic key (TK), is shown in FIG. 4. In the example shown in FIG. 4, a Media Stream (MS) 402 is sent using a TK 404 and BA 405. MS 402 is encrypted using TK 404 to form MS′ 406, TK 404 is encrypted using the SK to form TK′ 408, and BA 405 is encrypted with the SK and TK 404 to form BA′ 409. The characteristics of BA′ are shown in block 412: BA 405 is encrypted with the SK and TK 404 such that the application can not alter BA 405 and use it with the corresponding TK 404. Furthermore, an application can not use non-corresponding, TKs and BAs to decrypt the media stream. BA can be made public for application use. The TKs are frequently changed to limit or eliminate the usefulness of rogue applications sharing the TK with others. Since BA 405 is encrypted using the SK and the current TK, each time the TK is changed, a new BA′ is generated. Thus, a plurality of blocks of MS′ 414 are transmitted, each block tagged with an indication of the TK that was used to encrypt it. A plurality of TK's are transmitted periodically on a separate channel, to be used to decrypt the corresponding blocks of MS′. In addition, a plurality of BA's are transmitted.

In another example, the BA is provided in the clear, with a signature:
TK′=E(TK,SK)
BA
BAsig=H(BA+TK)

In this case (or if the SM exposes the decrypted BA), the BA are public and can be used by the application such that, at its discretion and in combination with the known AP, display a message to the user explaining why a content stream may not be available for viewing at this time. For example, “You are not allowed to view channel X during prime-time hours. Please tune back in after 7:00 PM, or upgrade your subscription now for unlimited access by pressing Upgrade below.”

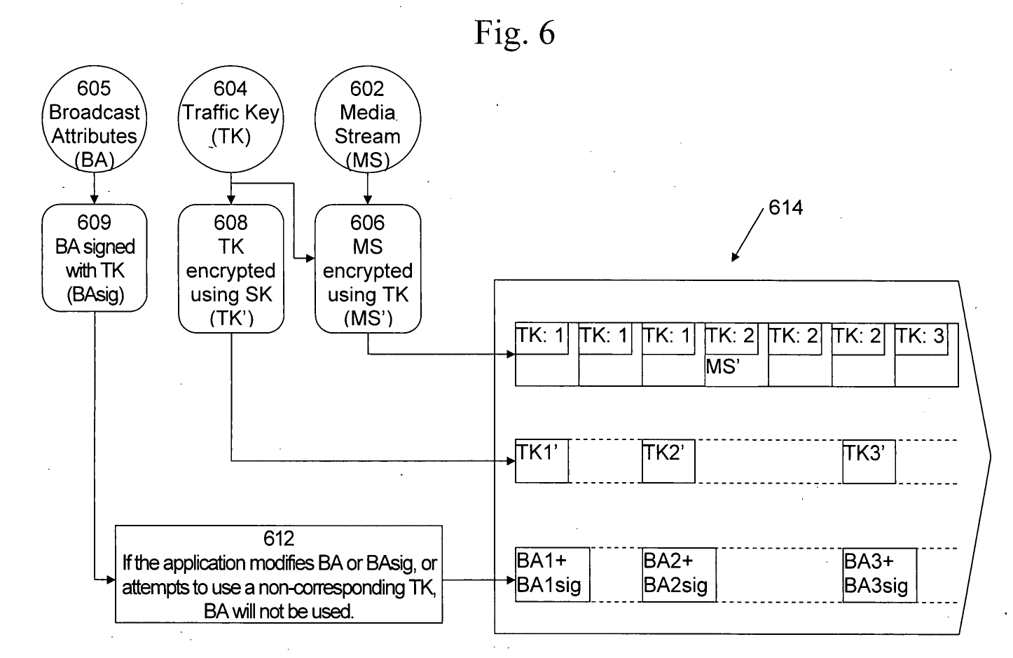

An example of this, in which the Broadcast Attributes (BA) are signed with the Traffic Key (TK), is shown in FIG. 6. In the example shown in FIG. 6, a Media Stream (MS) 602 is sent using a TK 604 and BA 605. MS 602 is encrypted using TK 604 to form MS′ 606, TK 604 is encrypted using the SK to form TK′ 608, and BA 605 is signed with TK 604 to form BAsig 609. The characteristics of BA and BAsig are shown in block 612: If the application modifies BA 605 or BAsig 609, or attempts to use a non-corresponding TK 604, these modifications or attempts will be detected and BA will not be used. The TKs are frequently changed to limit or eliminate the usefulness of rogue applications sharing the TK with others. Since BA 605 is encrypted using the SK and the current TK, each time the TK is changed, a new BA′ and a new BAsig are generated. Thus, a plurality of blocks of MS′ 614 are transmitted, each block tagged with an indication of the TK that was used to encrypt it. A plurality of TK's are transmitted periodically on a separate channel, to be used to decrypt the corresponding blocks of MS′. In addition, a plurality of BA's and BAsigs are transmitted.

The mechanisms above involve modification of the protocols for key distribution slightly, to add extra information to the broadcast of TK (an extra keystream or modification of the TK keystream itself). In circumstances where it is not desirable to change the way in which the TK is distributed (perhaps to keep bandwidth usage down), a third method involves embedding the BA within the TK:
TK′=E(TKreduced+BA, SK)

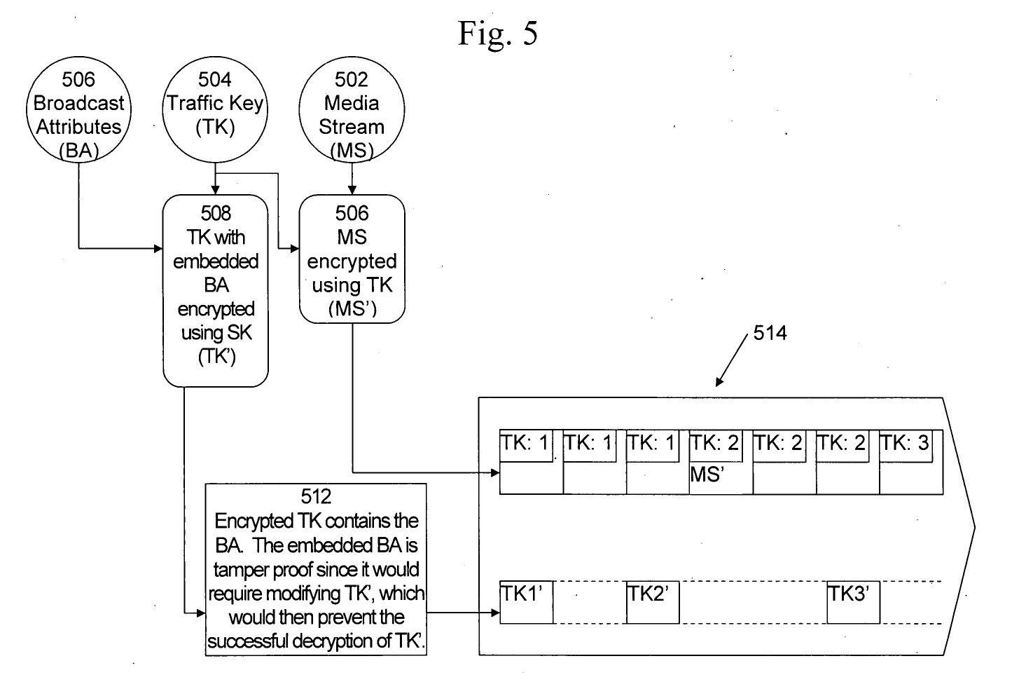

An example of this, in which the Broadcast Attributes (BA) Embedded in the Traffic Key (TK), is shown in FIG. 5. In the example shown in FIG. 5, a Media Stream (MS) 502 is sent using a TK 504 and BA 505. MS 502 is encrypted using TK 504 to form MS′ 506, and TK 504 with embedded BA 506 is encrypted using the SK to form TK′ 508. The characteristics of TK′ are shown in block 512: Encrypted TK′ 508 contains the BA 506. The embedded BA 506 is tamper proof since it would require modifying TK′, which would then prevent the successful decryption of TK′. The TKs are frequently changed to limit or eliminate the usefulness of rogue applications sharing the TK with others. Thus, a plurality of blocks of MS′ 514 are transmitted, each block tagged with an indication of the TK that was used to encrypt it. A plurality of TK's are transmitted periodically on a separate channel, to be used to decrypt the corresponding blocks of MS′. Each TK′ also includes an embedded BA 506.

In this case, the TKs may lose some randomness, but the TK/BA can not be altered by the application to gain access to the broadcast stream even if it knows how and where the BA are stored within the TK.

Note that a similar technique could be used for SK, though this is less advantageous.

The broadcast network provider adds BA along with, or embedded in, the TK as it is distributed. The BA may include environment data such as:
current date and time
current time of day, perhaps something with low granularity such as “morning” or “prime-time”
cell tower location broadcasting the media stream

The BA may include information specific to the broadcast itself, such as:
parental control rating
blackout indicator

Trusted local information can be made available to the secure module on the broadcast receiver to supplement, or replace, the broadcast BA. This information can be broken up into four categories: local network environment, device profile data, user profile data, and usage history. Examples of the local network environment include:
GPS location
signal strength

Examples of the device profile include:
ability to record broadcasts
ability to retransmit broadcasts

Examples of the user profile include:
age
gender
interests
credit rating

Examples of the usage history include:
recent broadcasts received
how long the current broadcast stream has been viewed
recent applications used

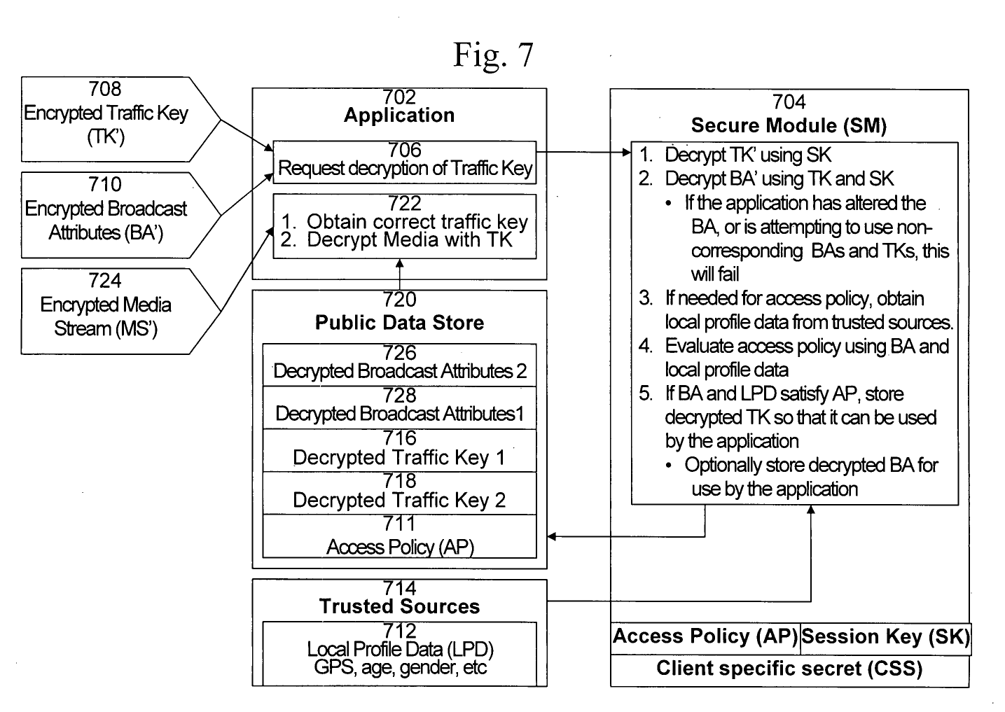

FIG. 7 illustrates a process by which an application 702 calls the secure module 704 to request 706 decryption of encrypted traffic keys 708 by providing the encrypted associated broadcast attributes 710. The secure module 704 first decrypts the encrypted TK, TK′ 708, using the unencrypted SK. The SM 704 then uses both the SK and newly decrypted TK to decrypt or verify the BA. The unencrypted SK is only known to the SM, meaning no application on the device can decrypt the TK or BA in an attempt to modify them and gain access to the content stream. If the application has altered the BA, or is attempting to use non-corresponding BAs and TKs, decryption of the TK and/or verification of the BA will fail. After securely obtaining the BA, the SM 704 can apply the attributes to the access policy (AP) 711. Additional local profile data (LPD) 712 may be obtained from trusted sources 714 by the SM 704 and used in conjunction with the BA to evaluate the AP. If the BA and LPD satisfy the conditions set forth in the AP, the decrypted TK 716 or 718 is stored in a public location, such as public data store 720, so that applications 702 on the device can use it to decode 722 the encrypted media stream 724 for the time period for which the TK is valid. If the BA was encrypted, the SM 716 may also decide to store the decrypted BA 726 or 728 in a public location, such as public data store 720, so that applications can use them to display helpful information to the user.

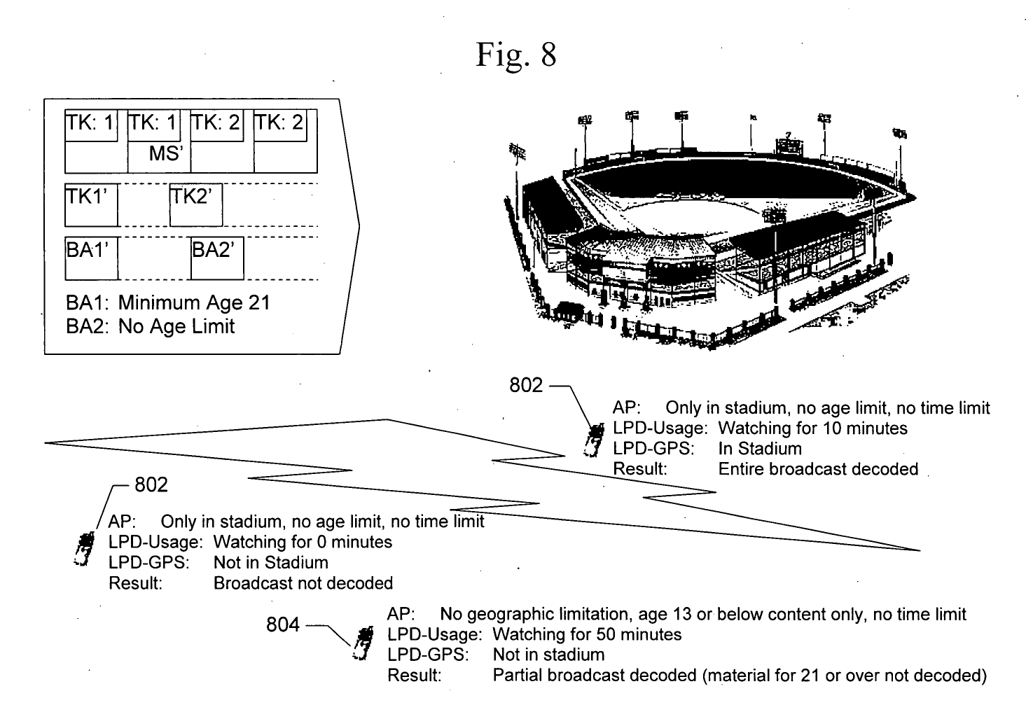

An example of this process is shown in FIG. 8. In this example there are two APs defined previously:

AP for user 1 802: Only allow viewing of broadcast if:

GPS location of the device is within a baseball park
Content rating of;broadcast is appropriate for those aged under 21
The user has been viewing the broadcast program for less than 30 minutes
   AP for user 2 804: Only allow viewing of broadcast if:
GPS location of the device is within a baseball park

Say that the broadcast stream contains a live baseball game, where commercials are broadcast between innings. Some of the commercials are for beer, which are deemed inappropriate for minors. The broadcaster can define a traffic key whose period of validity coincides with the beer commercial. The associated broadcast attributes for this specific traffic key indicate that the material is suitable only for those aged 21 and above. The broadcast attributes for traffic keys before and after the commercial indicate that the material is suitable for all ages.

When receiving the beer commercial traffic key and associated broadcast attributes, the application on each user's device calls the SM to decrypt the TK. Since both APs require that the device be located within the ballpark, the SM obtains GPS information from a local trusted source. The access policy rule, “GPS location of the device is within a baseball park” is really a simplification for comparing the latitude and longitude of the device and comparing it to set of well know latitudes and longitudes for all ballparks where reception of the broadcast is allowed. Assuming that both users are located within a ballpark, user 2's 804 SM will approve decryption of TK since the AP is satisfied. User 1's 802 SM will approve the GPS requirement, but will reject the TK since the rule “Content rating of broadcast is appropriate for those aged under 21” is not satisfied. Assuming that both the AP and BA are available to the application, the application can decide to show something else during the beer commercial, or simply display a message to the user indicating that the current broadcast contains inappropriate material and to stand by.

When receiving TKs after the beer commercial, user 1's 802 SM will approve the “Content rating of broadcast is appropriate for those aged under 21” rule. This leaves the last requirement of the AP to be satisfied, “The user has been viewing the broadcast program for less than 30 minutes”. The SM can keep track of the length of time the user has been viewing the content by counting the number of TK decryption requests. If the user has been viewing the broadcast for less than 30 minutes, the TKs are decrypted and made available to application for decoding the broadcast.

Though similar subscriber control can be exerted at the SK granularity, this is typically insufficient due to the desire to have finer control service level protection on a per-subscriber basis. It would be possible to modify the media stream itself to contain attributes concerning the broadcast which could then be used to filter subscriber access to the broadcast, but this method can not easily be made secure. The security module is not be involved in media packet decryption. Additionally, the overhead would be significantly greater than the periodic traffic key associated processing, since each media packet would need to be validated to ensure the access policy is satisfied. This invention describes an efficient method to use existing traffic key decryption methodologies to allow restriction of broadcast content on a subscriber-by-subscriber basis.

A number of applications of this invention can be used to enhance the services that can be made available by broadcasters to their subscribers:
Broadcast channel preview. The broadcast channel content can be made freely available to everyone for a period of time after issuance of the session key. The restriction policy can indicate for how long a particular user can preview the channel before being asked to subscribe to continue access to that channel. Either the BA would contain the time, or the security module would have access to the current time. A broadcast news channel would be an excellent fit for this application, allowing everyone access to view the channel for the first few minutes, and then converting them to paying subscribers by offering continued access to that channel.
Broadcast event preview. For a particular broadcast channel, each broadcast event can be previewed for a specified period of time. The restriction policy can indicate for how long a particular user can preview an event before being asked to subscribe to continue access to that event. The BA could contain a value indicating for how long the current event has been broadcast. Broadcasting sporting events or movies on a movie channel would be natural fits, allowing everyone access to view each sporting event or movie for the first few minutes, and then offering to convert them to paying subscribers for continued access to that broadcast. Subscribers could be offered access to the one event or movie only, or general access to all content offered by the channel.
Non-aligned prepaid time intervals. The broadcaster can offer subscription periods that are not aligned with the transmittal of the session key associated with that channel. Using current methods, if session keys are broadcast weekly, any subscriber having access to that broadcast channel would get access for the full lifetime of the session key, one week. If the broadcaster wanted to provide subscriptions that started at any time during the week, users whose subscriptions expire in the middle of the week would continue to have access to the broadcast content until the beginning of the following week, when the next session key is broadcast. By way of this invention, access to the broadcast channel can be revoked at the precise end of the subscription period even though the subscriber continues to have a valid session key. This is accomplished by specifying the subscription end time in the restriction policy, and giving secure and trusted access for the current time to the security module, possibly by providing the time in the traffic key metadata.
Parental control. The broadcaster can offer a service that delivers content of varying maturity level on the same channel. Parents can be given the ability to block content that is of a maturity level inappropriate for the subscriber viewing the broadcast. In this case, the restriction policy would contain the allowable content types. The traffic key metadata for a particular broadcast would contain the maturity level of the content during the period of time the traffic key is valid. If the maturity level restriction is not met, the broadcast, or just the portion of the broadcast not meeting the criterion would be blocked.
Parental control-enhanced. The application described above can be enhanced to provide, in a single broadcast, multiple maturity level versions of the same broadcast without the need for multiple dedicated channels. When showing movies on a television channel that may have younger viewers, certain clips of the movie may be cut, or “bleeped” out, or language changed to suit the maturity level of the audience. This often reduces the enjoyment of the broadcast for more mature audiences. For many movies, the parts that must be edited represent a small portion of the overall movie, especially in circumstances where only the audio part of the movie needs modification to be suited to different maturity levels. The extra media that needs to be broadcast to support multiple maturity levels is a small delta to the overall broadcast, and can be included in the same stream. Two traffic keys, along with the associated traffic key metadata can be used during the times where the movie would need to be presented differently to subscribers of varying maturity levels. The application would attempt to decode the highest maturity level first, and if denied, attempt to decode the less mature version of the same broadcast.
Event or time-of-day blackout. Broadcasters can offer different levels of service to the same broadcast stream; allowing premium subscribers access to content that is not available to regular subscribers. All subscribers to a particular broadcast steam would be allowed to view the stream except during special blackout periods, which could be event related, or time of day related (for example, prime-time). The restriction policy would signify if a particular subscriber is subject to blackouts, and the traffic key metadata would contain a flag to indicate if the current content is subject to blackout. If both are true, the subscriber would not be able to decode the broadcast, and an opportunity to up sell to that subscriber is afforded.
Limited time access to a broadcast channel. Broadcasters, or parents of minor subscribers, may want to limit the amount of time a subscriber can view a broadcast channel over a particular period of time. For example, the limit may be no more than 2 hours per day. In this case, the secure module would need to be able to monitor the amount of time that the receiver's device has viewed a particular broadcast stream. This could easily be accomplished by a single counter that gets incremented each time a traffic key is decoded, and can be reset given a particular event (e.g., start of day).
Player/team/fantasy statistics for sporting events available only to premium subscribers. Another application using this invention would be to enhance the experience for premium subscribers for broadcast sporting events. Included in the sporting event broadcast would be detailed team, player, and fantasy statistics. Only those with a premium subscription filter would be able to decode and view the additional statistics. The traffic key metadata would indicate if the media stream packet referenced contained premium statistics information, and only those with the allow premium content filter in the session key filter specification would be allowed to decode and view the statistics.

These examples provide only a sample of the many applications that this invention allows. Numerous other applications can easily be envisioned using the invention herein described.

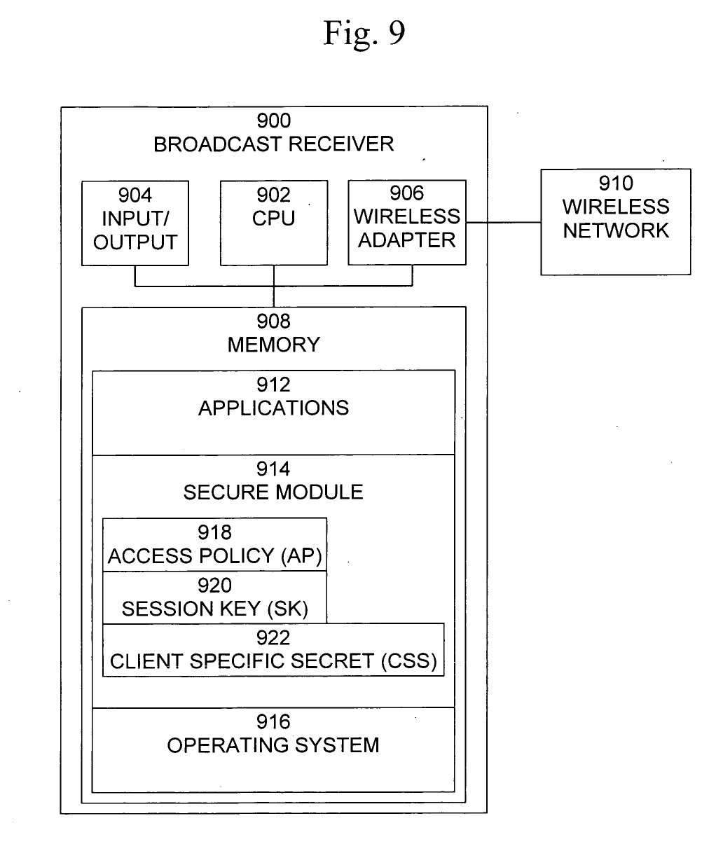

A block diagram of an exemplary broadcast receiver 900, in which the present invention may be implemented, is shown in FIG. 9. Broadcast receiver 900 typically a programmed micro-computer or micro-controller. Broadcast receiver 900 includes processor (CPU) 902, input/output circuitry 904, network adapter 906, and memory 908. CPU 902 executes program instructions in order to carry out the functions of the present invention. Typically, CPU 902 is a microprocessor, such as an INTEL PENTIUM® processor, but may also be a minicomputer or mainframe computer processor. Although in the example shown in FIG. 9, broadcast receiver 900 is a single processor system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which broadcast receiver 900 is implemented on a plurality of networked systems, which may be single-processor computer systems, multi-processor computer systems, or a mix thereof.

Input/output circuitry 904 provides the capability to input data to, or output data from, computer system 900. For example, input/output circuitry may include input devices, such as keyboards, mice, touchpads, trackballs, scanners, etc., output devices, such as video adapters, monitors, printers, etc., and input/output devices, such as, modems, etc. Wireless adapter 906 interfaces computer system 900 with wireless network 910. Wireless network 910 may be any standard wireless network, such as a Wi-Fi network, or wireless network may be a private or proprietary network.

Memory 908 stores program instructions that are executed by, and data that are used and processed by, CPU 902 to perform the functions of the present invention. Memory 908 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 908 includes applications 912, secure module 914, and operating system 916. Applications 912 include software that uses or is the destination for broadcast content included in a media stream. Secure module 914 is software (or in alternative implementations, hardware) that securely stores data and performs certain functions, such as allowing or denying a user access to a particular media stream by controlling decryption of traffic keys. The secure module includes or uses. Access Policy (AP) 918, Session Key (SK) 920, and Client-Specific Secret (CSS) 922. Access Policy 918 is used to evaluate whether or not a particular traffic key should be decrypted at the current time, given the inputs received from the broadcast attributes (BA) and local profile data (LPD). Session key 920 is used to allow users access to broadcasts on a particular broadcast channel for a specified amount of time. Client-Specific Secret 922 is an identifier that can be used to uniquely identify every device in a network. It is stored in the SM, and is known only to the SM and the service provider. Operating system 912 provides overall system functionality.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. For example, the present invention may be advantageously employed in scanning outgoing email messages, as well as incoming email messages. Accordingly, it is to be understood that the invention is not to be limited by the specific illustrated embodiments, but only by the scope of the appended claims.

What is claimed is:

1. A method of handling a multimedia broadcast in a device comprising:
receiving broadcast content in a media stream encrypted using a traffic key;
receiving the traffic key encrypted using a session key; and
receiving broadcast attributes encrypted using the traffic key and the session key, wherein use of the media stream by the device is controlled using the broadcast attributes and using an access policy in the device.

2. The method of claim 1, wherein the access policy defines restrictions on use of the media stream.

3. The method of claim 2, wherein the defined restrictions on viewing of the media stream are on a subscriber-by-subscriber basis.

4. The method of claim 1, further comprising:
using the broadcast attributes to evaluate whether the access policy is satisfied for a current broadcast content; and
preventing decryption of the traffic key if the access policy is not satisfied for the current broadcast content.

5. The method of claim 4, wherein using the broadcast attributes to evaluate whether the access policy is satisfied for a current broadcast content is based on an age of a user of the device and on a rating of the broadcast content.

6. The method of claim 4, wherein using the broadcast attributes to evaluate whether the access policy is satisfied for a current broadcast content is based on geographic area.

7. The method of claim 6, wherein the geographic area includes at least one of a city, a road, an airport, a public transportation terminal, a sports arena, an amusement park, a museum, and a public or private place of business.

8. The method of claim 4, wherein using the broadcast attributes to evaluate whether the access policy is satisfied for a current broadcast content is based on a time of day.

9. The method of claim 4, wherein using the broadcast attributes to evaluate whether the access policy is satisfied for a current broadcast content is based on additional data included in the media stream.

10. The method of claim 4, wherein using the broadcast attributes to evaluate whether the access policy is satisfied for a current broadcast content is based on additional data included in the broadcast content that is only made available to selected members.

11. The method of claim 10, wherein the additional data includes at least one of: fantasy sporting even information, sporting event information, information related to characters or actors playing those characters, information related to locations or props, information related to writers, directors, producers, or others involved in production of the broadcast content, commentary concerning the broadcast content, and additional languages for the broadcast content.

12. The method of claim 4, wherein using the broadcast attributes to evaluate whether the access policy is satisfied for a current broadcast content is based on expiration information of a user subscription.

13. The method of claim 4, wherein using the broadcast attributes to evaluate whether the access policy is satisfied for a current broadcast content is based on allowing a user to view a particular broadcast stream for only a specified amount of time, based on a count of a number of traffic keys decrypted.

14. The method of claim 1, further comprising:
using at least one of the broadcast attributes, local device information, user profile information, and history information to evaluate whether the access policy is satisfied for a current broadcast content; and
preventing decryption of the traffic key if the access policy is not satisfied for the current broadcast content.

15. The method of claim 1, wherein the broadcast content comprises data used by an application on the device.

16. The method of claim 1, wherein the device is mobile device capable of displaying or otherwise using the media stream.

17. The method of claim 1, wherein the session key and the access policy are used to enable or restrict access to one or more related media streams or broadcast channels, wherein rights for each related media stream or broadcast channel are different.

18. The method of claim 17, wherein the access policy is received and securely stored in the device, such that the access policy can not be manipulated by applications on the device and cannot subsequently be used to decrypt a media stream.

19. The method of claim 17, wherein the access policy is made available to applications on the device for purposes including at least one of displaying the access policy to a user of the device, or altering a user interface by which the user gains access to the media stream or broadcast channel or views the media stream or broadcast channel.

20. The method of claim 1, wherein the access policy includes at least one of a set of parameter values, a set of ranges of parameter values, a set of regular expressions, a matching predicate, or a matching algorithm.

21. The method of claim 1, further comprising encrypting the traffic key using the broadcast attributes, thereby binding the broadcast attributes to the traffic key such that neither the traffic key nor the broadcast attributes can be modified by any application on the device and result in successful decryption of the media stream.

22. The method of claim 1, wherein the broadcast attributes are encrypted using the traffic key, thereby binding them to the traffic key such that neither the traffic key nor the broadcast attributes can be modified by any application on the device and result in successful decryption of the media stream.

23. The method of claim 22, wherein the broadcast attributes encrypted using the traffic key are available to an application on the device for purposes including modifying the user-interface based on the broadcast attributes or otherwise informing the user of the broadcast attributes.

24. The method of claim 1, wherein an application on the device is unable to use non-corresponding broadcast attributes and traffic keys to successfully satisfy the access policy and decrypt the media stream.

25. The method of claim 1, wherein the broadcast attributes are embedded in the encrypted traffic key, and the broadcast attributes are not received separately from the encrypted traffic key.

26. The method of claim 1, wherein the received broadcast attributes include metadata relating to the media stream, including at least one of a content type of the media stream, and a content rating of the media stream.

27. The method of claim 1, wherein the received broadcast attributes include network environment data, including at least one of as a broadcast tower location, a time of day, traffic information, and network status data.

28. The method of claim 1, further comprising:
using additional profile information not included with the media stream to determine whether the device can decrypt the received traffic keys, wherein the additional profile information includes at least one of:
local network environment data, including at least one of: a GPS location of the device, a quality of service, a time zone, a signal strength, and other local network environment data of the device;
device-specific data, including at least one of: an ability of the device to record a media stream, an ability of the device to retransmit a media stream, and other device-specific capabilities;
user-specific profile data, including at least one of: a gender of a user of the device, an age of the user of the device, and interest of the user of the device, and other data relating to a user of the device; and
usage history of the device, including at least one of: usage of a media stream or broadcast channel, usage of applications on the device, and other data relating to how the device has been previously used.
